(19) United States
(12) Patent Application Publication
(10) Pub. No.: US 2016/0060380 A1
(43) Pub. Date: Mar. 3, 2016

(54) HYDROPHILIC POLYASPARTIC ESTERS

(71) Applicant: Bayer MaterialScience AG, Monheim Am Rhein (DE)

(72) Inventors: Hans-Josef Laas, Odenthal (DE); Michael Grahl, Leverkusen (DE); Olaf Fleck, Bergisch-Gladbach (DE); Hans-Ulrich Meyer-Westhues, Leverkusen (DE); Michèl La Faille, Roosendaal (NL)

(21) Appl. No.: 14/836,144

(22) Filed: Aug. 26, 2015

(30) Foreign Application Priority Data
Aug. 29, 2014 (EP) 14182763.4

(51) Int. Cl. C08G 18/34; C09D 175/02; C08G 18/77

(52) U.S. Cl. CPC C08G 18/341; C08G 18/771; C09D 175/02

(57) ABSTRACT

Disclosed are polyaspartic esters obtainable by reaction of at least one polyamine component A), comprising an amine compound of the formula (I),

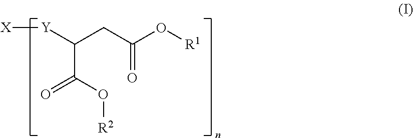

where
X is a saturated or unsaturated, linear or branched, aliphatic or cycloaliphatic or aromatic organic radical which is substituted or unsubstituted and/or has heteroatoms in the chain,
Y is a secondary amino group bonded to two carbon atoms,
R¹ and R² independently of one another are saturated or unsaturated, linear or branched, aliphatic or cycloaliphatic or aromatic organic radicals having 1 to 18 carbon atoms, and are substituted or unsubstituted and/or have heteroatoms in the chain, and
n is a natural number from 1 to 4,
   with at least one polyisocyanate component B), comprising a polyisocyanate which contains at least one chemically bonded, non-ionic, hydrophilic group, characterized in that the ratio of the number of secondary amino groups Y to the number of isocyanate groups in the polyisocyanate is from 250:1 to 3:1. Further disclosed is a method for producing a coating composition, a 2-component system, the use thereof for producing a coating on a substrate, and the substrates coated accordingly.

### FIELD OF THE INVENTION

The invention relates to hydrophilic polyaspartic esters, to mixtures, solutions or dispersions thereof, and to polyurethaneureas obtainable from the hydrophilic polyaspartic esters. A further subject of the invention is a method for producing a coating composition from the hydrophilic polyaspartic esters. Furthermore, a 2-component system comprising the hydrophilic polyaspartic esters, its use for producing a coating on a substrate, and the substrates coated accordingly, are further subjects of the invention.

### BACKGROUND OF THE INVENTION

Hydrophilic polyaspartic esters of the type described above are disclosed in EP-A 1 616 889. That publication describes reaction products of diamines with specific maleic esters, containing ether groups, as a binder component for aqueous coating systems. Because of the drastic reaction conditions required for the preparation process, the maleic esters in question, and also the hydrophilic polyaspartic esters obtainable from them, have a strong inherent colour, making them unsuitable for the majority of coatings applications.

### BRIEF SUMMARY OF THE INVENTION

It was the object of the present invention, therefore, to provide hydrophilic polyaspartic esters having Hazen colour numbers, measured spectrophotometrically in accordance with DIN EN 1557, of 5 to 100 Hazen, which can be dispersed or dissolved outstandingly in water and from which it is possible to produce colourless coatings, particularly through reaction with hydrophilic polyisocyanates.

This object is achieved through the hydrophilic polyaspartic esters of the invention, which are obtainable by reaction of at least one polyamine component A), comprising an amine compound of the formula (I),

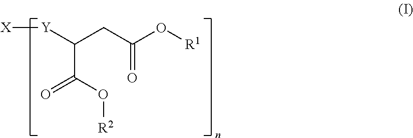

in which
X is a saturated or unsaturated, linear or branched, aliphatic or cycloaliphatic or aromatic organic radical which is substituted or unsubstituted and/or has heteroatoms in the chain,
Y is a secondary amino group bonded to two carbon atoms,
R¹ and R² independently of one another are saturated or unsaturated, linear or branched, aliphatic or cycloaliphatic or aromatic organic radicals having 1 to 18 carbon atoms, and are substituted or unsubstituted and/or have heteroatoms in the chain, and
n is a natural number from 1 to 4,
   with at least one polyisocyanate component B), comprising a polyisocyanate which contains at least one chemically bonded, non-ionic, hydrophilic group, the ratio of the number of secondary amino groups Y to the number of isocyanate groups in the polyisocyanate being from 250:1 to 3:1.

### DETAILED DESCRIPTION OF THE INVENTION

According to one first preferred embodiment of the invention, the ratio of the number of secondary amino groups Y in the formula (I) to the number of isocyanate groups in the polyisocyanate is from 200:1 to 5:1, preferably 150:1 to 6:1 and more preferably 120:1 to 8:1.

In order to achieve improved solubility in polar solvents, the polyisocyanate has at least one chemically bonded, non-ionic, hydrophilic group.

In another preferred embodiment, for example, polyalkylene oxide polyether units are suitable as a chemically bonded, non-ionic, hydrophilic group. These units may comprise mono-, di- or polyfunctional, preferably mono- or difunctional and more preferably monofunctional polyalkylene oxide polyether alcohols of the kind obtainable, for example, through reaction of suitable starter molecules with at least one alkylene oxide. Examples of suitable alkylene oxides are ethylene oxide and propylene oxide. The starter molecules may be any mono-, di- or polyfunctional alcohols of the molecular weight range 32 to 300, examples being methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetane, 1,2-ethanediol, 1,2- and 1,3-propanediol, the isomeric butanediols, pentanediols, hexanediols, heptanediols and octanediols, 1,2- and 1,4-cyclohexanediol, 1,4-cyclohexanedimethanol, 4,4′-(1-methylethylidene)biscyclohexanol, 1,2,3-propanetriol, 1,1,1-trimethylolethane, 1,2,6-hexanetriol, 1,1,1-trimethylolpropane, 2,2-bis(hydroxymethyl)-1,3-propanediol, 1,3,5-tris(2-hydroxyethyl) isocyanurate or any desired mixtures of these alcohols. Especially preferred polyalkylene oxide polyether alcohols are those prepared using as starter molecules the abovementioned monoalcohols of the molecular weight range 32 to 150.

According to another preferred embodiment, the chemically bonded, non-ionic, hydrophilic group comprises at least one polyalkylene oxide polyether unit which consists to an extent of ≧40 mol %, preferably ≧50 mol % and more preferably ≧70 mol % of ethylene oxide units and/or which has on average 5 to 80, preferably 5 to 50 and more preferably 5 to 30 ethylene oxide units. Through this non-ionic, hydrophilic group it is possible to achieve very good solubility or dispersibility of the hydrophilic polyaspartic esters in polar solvents, preferably in water. For this preferred embodiment, the hydrophilic polyaspartic esters of the invention offer a particular advantage as a result of the outstanding dispersibility, in spite of comparatively low ethylene oxide contents, since it is possible in this way, by using these esters, to obtain coatings which have an excellent water resistance in particular, by virtue of the low level of hydrophilic groups.

In one particularly preferred embodiment, the polyalkylene oxide polyether unit comprises pure polyethylene glycol monomethyl ether alcohols, which have on average 5 to 80, preferably 5 to 50 and more preferably 5 to 30 ethylene oxide units. By this means the solubility or the dispersibility of the hydrophilic polyaspartic esters of the invention is improved still further.

A development of the invention provides for the polyisocyanate to be possibly at least one aliphatic, cycloaliphatic, araliphatic or aromatic, preferably at least one aliphatic or cycloaliphatic, polyisocyanate.

In this context it is further preferred for the polyisocyanate possibly to comprise, in addition to at least one chemically bonded, non-ionic, hydrophilic group, as a further synthesis component, one or more diisocyanates of the molecular weight range 140 to 400. Preferred diisocyanates are 1,4-diisocyanatobutane, 1,5-diisocyanatopentane, 1,6-diisocyanatohexane (HDI), 1,5-diisocyanato-2,2-dimethylpentane, 2,2,4- and/or 2,4,4-trimethyl-1,6-diisocyanatobexane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-di isocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (XDI), 1,3- and 1,4-bis(1-isocyanato-1-methylethyl)benzene (TMXDI), bis(4-(1-isocyanato-1-methylethyl)phenyl)carbonate, 1,3- and 1,4-phenylene diisocyanate, 2,4- and 2,6-tolylene diisocyanate (TDI) and also any desired mixtures of these isomers, diphenylmethane 2,4′- and/or 4,4′-diisocyanate (MDI) and naphthylene 1,5-diisocyanate (NDI). Further diisocyanates, likewise suitable, are found, furthermore, in Justus Liebigs Annalen der Chemie volume 562 (1949) pp. 75-136, for example.

Particularly preferred diisocyanates are 1,5-diisocyanatopentane, 1,6-diisocyanatohexane (HDI), 1-isocyanato-3,3,5-trimethyl-5-isocyanatomethylcyclohexane (isophorone diisocyanate; IPDI) and/or 2,4′- and 4,4′-diisocyanatodicyclohexylmethane (H12-MDI).

In another preferred embodiment it is also possible, when using aliphatic and/or cycloaliphatic diisocyanates, for diisocyanates having aromatically bonded isocyanate groups to be likewise present, in a deficit molar amount, based on the total amount of free isocyanate groups. Polyisocyanates of this kind with mixed aliphatic/aromatic structure are already known and are obtainable for example in accordance with EP-A 0 680 983 through reaction of polyethylene oxide polyethers with mixtures of polyisocyanates of low monomer content based on HDI and those based on 2,4(6)-diisocyanatotoluene (tolylene diisocyanate, TDI).

According to another preferred embodiment, the polyisocyanate contains allophanate groups and has optionally up to 10 mol %, preferably up to 5 mol %, of isocyanurate groups and/or uretdione groups, based on the total amount of allophanate, isocyanurate and uretdione structures.

In another particularly preferred embodiment, the polyisocyanate has an average isocyanate functionality of 1.0 to 3.0, preferably of 1.5 to 2.5 and more preferably of 1.8 to 2.2, an isocyanate group content of 3 to 25 wt %, preferably 4 to 20 wt % and more preferably of 5 to 15 wt %, and contain from 5 to 80 wt %, preferably from 5 to 75 wt % and more preferably from 10 to 70 wt % of ethylene oxide units bonded within polyalkylene oxide polyether units, the polyalkylene oxide polyether units having on average 5 to 80, preferably 5 to 50 and more preferably 5 to 30 ethylene oxide units.

With regard to the amine compound of the formula (I), a further preferred embodiment provides for n in the formula (I) to be a natural number from 1 to 3, preferably 1 or 2 and more preferably 2.

It is likewise preferred if X in the formula (I) is an organic radical having a molecular weight of 28 g/mol to 6000 g/mol, preferably 45 to 5000 g/mol and more preferably 84 to 500 g/mol.

According to another preferred embodiment, X in the formula (I) is selected from a group of organic radicals obtained when the amino groups of the compounds having a molecular weight of 60 to 238 g/mol, such as, for example, ethylenediamine, 1,2-diaminopropane, 1,4-diaminobutane, 1,5-diamino-2-methylpentane (Dytek® A from DuPont), 1,6-diaminohexane, 2,5-diamino-2,5-dimethylhexane, 2,2,4- and/or 2,4,4-trimethyl-1,6-diaminohexane, 1,11-diaminoundecane, 1,12-diaminododecane, I-amino-3,3,5-trimethyl-5-aminomethylcyclohexane (IPDA), 1,3-diamino-2- and/or -4-methylcyclohexane, isopropyl-2,4- and/or 2,6-diaminocyclohexane, 1,3-bis(aminomethyl)cyclohexane, 2,4′- and/or 4,4′-diaminodicyclohexylmethane, 3,3′-dimethyl-4,4′-diaminodicyclohexylmethane (Laromin® C 260; BASF SE, Ludwigshafen, DE), the isomeric diaminodicyclohexylmethanes having a methyl group as ring substituent (C-monomethyl-diaminodicyclohexylmethanes), 3(4)-aminomethyl-1-methylcyclohexylamine and 1,3-bis(aminomethyl)benzene, are removed, and n is the natural number 2, suitably.

In another preferred embodiment, X in the formula (I) is selected from the group of organic radicals obtained when the amino groups of compounds which comprise at least one groups which is different from amino groups and which is reactive towards isocyanate groups in the temperature range from 20 to 200° C. are removed, and n is the natural number 1 or 2. The compounds in question in this case may be, for example, amino alcohols, such as 2-aminoethanol, the isomeric aminopropanols and -butanols, 3-amino-, 2-propanediol and 1,3-diamino-2-propanol, for example.

Where n in the formula (I) is the natural number 3 or 4, X may be selected, for example, from a group of organic radicals obtained when the amino groups of the compounds 4-aminomethyl-1,8-octanediamine, 2,2′,2″-triaminotriethylamine, 1,3,5-tris(aminomethyl)-2,4,6-triethylbenzene, 1,1-trisaminoethylethane, 1,2,3-triaminopropane, tris(3-aminopropyl)amine and N,N,N′,N′-tetrakis(2-aminoethyl)ethylenediamine are removed. Additionally, low molecular weight polyether polyamines having aliphatically bonded primary amino groups, of the kind sold, for example, under the name Jeffamine (Huntsman Performance Products, The Woodlands, Tex., USA), are compounds suitable in principle in this context.

With particular preference, X in the formula (I) is selected from a group of organic radicals obtained when the amino groups of the compounds 1,5-diamino-2-methylpentane (Dytek® A from DuPont), 2,4′-diaminodicyclohexylmethane, 4,4′-diaminodicyclohexylmethane, 3,3′-dimethyl-4,4′-diaminodicyclohexylmethane (Laromin® C 260; BASF SE, Ludwigshafen, DE) or polypropylene glycol diamines of the molecular weight range 200 to 500 g/mol are removed, and n is the natural number 2. Examples of suitable propylene glycol diamines in this context are mixtures of Jeffamin®D-230 and Jeffamin® D-400 (Huntsman Performance Products, The Woodlands, Tex., USA).

In a further preferred embodiment, R¹ and R² in the formula (I) independently of one another are aliphatic organic radicals having 1 to 9 carbon atoms, preferably independently of one another methyl, ethyl, n-butyl and/or 2-ethylhexyl radicals and more preferably ethyl radicals.

According to another preferred embodiment, the hydrophilic polyaspartic ester mixture of the invention comprises compounds which have secondary amino groups and/or urea groups, the ratio of the number of secondary amino groups to the number of urea groups in the mixture being 249:1 to 2:1, preferably 199:1 to 4:1, more preferably 149:1 to 5:1 and very preferably 119:1 to 7:1.

The hydrophilic polyaspartic esters of the invention may also be described by the term “light in colour”, with the term “light in colour” being defined in the context of the present invention through aforementioned Hazen colour number range.

Amine compounds of the formula (I) may be prepared generally, for example, as described in EP-A 0 403 921, EP-A 0 689 881 or EP-A 0 816 326 by reaction of a compound of the formula (II) containing primary amino groups

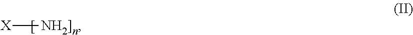

in which X and n conform to the definition indicated in the formula (I), with fumaric esters and/or maleic esters of the formula (III)

R¹OOC—CH═CH—COOR² (III)

in which R¹ and R² conform to the definition indicated in the formula (I).

Generally the stated compounds of the formula (II) may be used both individually and in the form of any desired mixtures with one another for preparing amine compounds of the formula (I). Additionally the fumaric esters and/or maleic esters of the formula (III) may be used both individually and in the form of any desired mixtures with one another for preparing amine compounds of the formula (I).

The preparation of the amine compound of the formula (I) may take place in the presence of an organic solvent. Suitable solvents for this purpose are especially those which behave inertly relative to the reactive groups of the starting components, examples being the customary paint solvents, such as, for example, ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, more highly substituted aromatics, of the kind available, for example, under the names Solvent naphtha, Solvesso®, Isopar®, Nappar® (Deutsche EXXON CHEMICAL GmbH, Cologne, DE) and Shellsol® (Deutsche Shell Chemie GmbH, Eschborn, DE), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents. With particular preference, however, the amine compound of the formula (I) is prepared without accompanying use of organic solvents. In that way it is possible for any residues of organic solvents in the amine compounds to be diminished or even avoided entirely.

Independently of the possible accompanying use of a solvent, the amine compound of the formula (I) may be prepared preferably by equimolar reaction of at least one compound of formula (II) with at least one fumaric ester or maleic ester of the formula (III). For tailored variation in performance properties, the equivalents ratio of maleic ester and/or fumaric ester of the formula (III) to amino groups of the compound of the formula (II) may be varied from 1.2:1 to 1:2.

The diisocyanates specified above may be prepared by known processes, as for example by phosgenation or by a phosgene-free route, such as by urethane cleavage, for example. From the stated diisocyanates it is possible to prepare, for example, polyisocyanates having uretdione, isocyanurate, allophanate, biuret, iminooxadiazinedione and/or oxadiazinetrione structure, as are described in references including J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299.

For the purpose of introducing the polyalkylene oxide polyether units into the polyisocyanate, the aforementioned polyisocyanates may be reacted, for example, with polyalkylene oxide polyether alcohols that have groups reactive towards isocyanate groups. The preparation of such polyisocyanates may be accomplished, for example, by the processes described in EP-A 206 059, EP-A 540 985 or U.S. Pat. No. 5,200,489, through reaction of polyisocyanates at low monomer content, having aliphatically and/or cycloaliphatically bonded isocyanate groups, with hydrophilic, monofunctional polyalkylene oxide polyether alcohols of the type stated above.

The polyisocyanates containing allophanate groups may be obtained, for example, by the processes described in EP-A 0 524 500, EP-A 0 566 037 or U.S. Pat. No. 5,086,175, through reaction of simple aliphatic and/or cycloaliphatic diisocyanates with polyalkylene oxide polyether alcohols of the type specified above, observing an NCO/OH equivalents ratio of 5:1 to 50:1, in the presence of a compound which accelerates the formation of allophanate groups and at the same time accelerates the trimerization and/or dimerization of isocyanate groups. After the reaction, the unreacted monomeric diisocyanate can be removed down to a residual level of less than 0.5 wt %.

Polyisocyanates particularly preferred in this context are difunctional polyisocyanates, containing

allophanate groups and optionally having isocyanurate groups and/or uretdione groups, the polyisocyanates being based on aliphatic and/or cycloaliphatic diisocyanates, obtainable, for example, by the process of EP-A 0 682 012 or as described by way of example in EP-A 0 850 896, through reaction of monofunctional polyether alcohols of the type specified above with a molar excess of diisocyanate in the presence of allophanatization catalysts and with subsequent removal of the unreacted monomeric diisocyanate.

“Optionally having isocyanurate groups and/or uretdione groups” means in this context that the allophanate polyisocyanates which are particularly suitable as polyisocyanate component B) may contain at most up to 10 mol %, preferably up to 5 mol %, of isocyanurate groups and/or uretdione groups, based on the total amount of allophanate, isocyanurate and uretdione groups.

The ratio of allophanate, isocyanurate and/or uretdione groups may be determined, for example, by an NMR-spectroscopic analysis. Here it is possible with preference to use ¹³C NMR spectroscopy, preferably with proton decoupling, since the allophanate, isocyanurate and/or uretdione groups yield characteristic signals.

For the preparation of the hydrophilic polyaspartic esters of the invention, the polyamine component A) may be reacted with the polyisocyanate component B), according to a further preferred embodiment, at temperatures of 0 to 120° C., preferably of 20 to 80° C., more preferably of 20 to 60° C.

The hydrophilic polyaspartic esters of the invention can be prepared in the presence of at least one solvent that is inert towards the reactive groups of the amine compound of the formula (I) and of the polyisocyanates. Examples of such solvents are the customary paint solvents, of the kind already described as solvents for optional accompanying use in the preparation of the amine compound of the formula (I). Such solvents are employed, if desired, in an amount of, for example, up to 70 wt %, preferably up to 60 wt %, more preferably up to 50 wt %. It is preferred, however, for the hydrophilic polyaspartic esters of the invention to be prepared without addition of solvent. In the latter case, the hydrophilic polyaspartic esters of the invention are distinguished by a low level of volatile organic compounds (VOC content).

In a further preferred embodiment, in the process for preparing the hydrophilic polyaspartic esters of the invention, the polyamine component A) can be introduced in the initial charge, optionally under inert gas, such as nitrogen, for example, and optionally in the presence of a solvent of the type specified above, at a temperature between 0 and 100° C. Subsequently the polyisocyanate component B), optionally together with further solvent, may be added at a rate such that the temperature of the reaction mixture does not exceed 120° C.

Irrespective of the particular embodiment, the course of the reaction of the polyamine component A) with the polyisocyanate component B) may be monitored by means of IR spectroscopy, for example. Following complete reaction of isocyanate groups and amino groups, as evident, for example, from the disappearance of the isocyanate band at around 2270 cm⁻¹ in the IR spectrum, products obtained are the hydrophilic polyaspartic esters of the invention in the form of clear resins, light in colour, which in solvent-free form at 23° C. typically have viscosities of 1000 to

20000 mPas, depending on the nature and amount of the starting compounds selected.

The hydrophilic polyaspartic esters of the invention are suitable for a multiplicity of applications. Hence they can be dispersed or dissolved, for example, in a solvent. Examples of suitable solvents are the customary, known paint solvents described in the context of the preparation of the amine compound of the formula (I). A further subject of the invention, therefore, are solutions or dispersions comprising at least one hydrophilic polyaspartic ester of the invention.

According to another preferred embodiment of the solutions or dispersions of the hydrophilic polyaspartic esters according to the invention, water is present as solvent, and preferably water is the sole solvent. According to this preferred embodiment, then, at least one further constituent of these solutions or dispersions is water. Particularly preferred also in this case is for water to be used as sole solvent. The aqueous solutions or dispersions can be prepared easily, without using high shearing forces, by simply stirring the hydrophilic polyaspartic esters of the invention into water. An advantage here is that through the use of water as solvent, it is possible to reduce the use of environmentally harmful substances.

According to a further preferred embodiment, the preferably aqueous solutions or dispersions have solids contents of 10 to 60 wt %, preferably 20 to 50 wt %, more preferably 30 to 45 wt %. An advantage is that such solutions or dispersions exhibit very good sedimentation stability.

Given that the hydrophilic polyaspartic esters of the invention, both in solvent-free form and in the form of above solutions or dispersions, possess free secondary amino groups, they are highly suitable, for example, for reaction with NCO-functional crosslinking agents.

A further subject of the invention, accordingly, is a polyurethaneurea obtainable by reaction of at least one hydrophilic polyaspartic ester of the invention with at least one NCO-functional crosslinking agent. Polyureas may be prepared in this case by the isocyanate polyaddition process.

NCO-functional crosslinking agents employed may be any desired hydrophobic and/or hydrophilically modified polyisocyanates, which may be used without blocking or blocked with the blocking agents known from polyurethane chemistry. Employed with particular preference in this context are hydrophobic and/or hydrophilically modified polyisocyanates having a viscosity, determined according to DIN EN ISO 3219, of ≦3000 mPas, preferably ≦2000 mPas, at 23° C. Optionally they may also be used as an aqueous solution or dispersion.

Suitable hydrophobic polyisocyanates are also, for example, besides the aforementioned polyisocyanates which contain at least one chemically bonded, non-ionic, hydrophilic group, hydrophobic polyisocyanates which are obtainable by modification of simple diisocyanates and which have uretdione, isocyanurate, allophanate, biuret, iminooxadiazinedione and/or oxadiazinetrione structure, with preference being given to those having viscosities as determined according to DIN EN ISO 3219 at 23° C. of ≦3000 mPas, preferably ≦2000 mPas.

Examples of suitable hydrophilically modified polyisocyanates are the aforementioned polyisocyanates containing at least one chemically bonded, non-ionic, hydrophilic group. Other suitable polyisocyanates may also be the polyisocyanate mixtures obtainable by the processes of EP-A 0 959 087 and EP-A 1 276 787, through reaction of polyisocyanates of low monomer content that consist of at least two diisocyanate molecules with monofunctional polyethylene oxide polyether alcohols, a reaction which involves allophanatization. Likewise suitable are the ionically modified polyisocyanate mixtures containing sulphonate groups that are known from WO 01/880006 and are obtainable by reaction of hydrophobic polyisocyanates with 2-(cyclohexylamino)ethanesulphonic acid and/or 3-(cyclohexylamino)propanesulphonic acid.

The above-described hydrophobic and/or hydrophilically modified polyisocyanates can also be used as 1-component systems, in a form in which they are blocked with blocking agents known from polyurethane chemistry. Examples of suitable blocking agents include diethyl malonate, ethyl acetoacetate, activated cyclic ketones, such as cyclopentanone-2-carboxymethyl ester and -carboxyethyl ester, acetone oxime, butanone oxime, c-caprolactam, 3,5-dimethylpyrazole, 1,2,4-triazole, dimethyl-1,2,4-triazole, imidazole, benzyl-tert-butylamine, for example, or any desired mixtures of these blocking agents. Where a solvent is to be used when using polyisocyanates blocked in this way, the use of water is particularly preferred.

Finally it is also possible through physical blending of external emulsifiers with hydrophobic polyisocyanates of the aforementioned kind to obtain hydrophilically modified polyisocyanate mixtures which are suitable as NCO-functional crosslinking agents for the hydrophilic polyaspartic esters of the invention.

External emulsifiers of this kind may be, for example, isocyanate-group-free reaction products of monomeric diisocyanates or diisocyanate mixtures with the suitable monofunctional or polyfunctional polyether alcohols stated above as for the preparation of the polyisocyanate components B), more particularly with pure polyethylene glycol monomethyl ether alcohols, of the kind described in EP-B 0 486 881, for example.

Another type of suitable external emulsifiers for modifying hydrophobic polyisocyanates are those which contain ionic and nonionic structures simultaneously in one molecule. These emulsifiers may be, for example, alkylphenol polyglycol ether phosphates and phosphonates or fatty alcohol polyglycol ether phosphates and phosphonates, neutralized with tertiary amines, these phosphates and phosphonates being of the kind described in WO 97/31960 for the hydrophilization of polyisocyanates, for example, or else they may be alkylphenol polyglycol ether sulphates or fatty alcohol polyglycol ether sulphates neutralized with such tertiary amines. Not only the hydrophilic polyaspartic esters of the invention themselves but also the mixtures and/or solutions or dispersions thereof are outstandingly suitable, for example, as binders for the formulation of paints and coating compositions, preferably for the formulation of aqueous paints and/or aqueous coating compositions.

Therefore a method for producing a coating composition is a further subject of the invention. In this method, at least one hydrophilic polyaspartic ester of the invention or at least one solution or

dispersion of the hydrophilic polyaspartic esters is mixed with at least one NCO-functional crosslinking agent. Particularly preferred in this context is the use of aqueous solutions or dispersions of the polyaspartic esters of the invention. In another particularly preferred embodiment, low-viscosity hydrophobic polyisocyanates, more particularly those having a viscosity of ≦2000 mPas as determined according to DIN EN ISO 3219 at 23° C., and/or hydrophilically modified polyisocyanates are employed as NCO-functional crosslinking agents. As well as being used without solvent, they may also be used in the form of solutions or dispersions.

In the preparation of the paints and coating compositions from the hydrophilic polyaspartic esters of the invention and/or solutions or dispersions thereof, preferably aqueous dispersions thereof, the stated NCO-functional crosslinking agents are used in general in amounts which correspond to an equivalents ratio of amino groups to optionally blocked isocyanate groups of 2:1 to 0.5:1, preferably of 1.5:1 to 0.8:1, more preferably of 1.1:1 to 0.9:1.

The mixing of the hydrophilic polyaspartic esters of the invention with the NCO-functional crosslinking agent, which where hydrophilically modified polyisocyanates are used may optionally be present in the form of a preliminary emulsion in water, can be accomplished by simple stirring together before the processing of the coating compositions, by any desired techniques, through use of mechanical assistants known to the skilled person, or else using 2-component spray guns.

The solutions or dispersions of the hydrophilic polyaspartic esters of the invention, preferably aqueous solutions or dispersions, can be used not only as sole binder but also in combination with further film-forming binders or film-forming binder components, optionally in solution or dispersion in water, which preferably likewise carry groups that are reactive towards isocyanate groups.

Examples of suitable combination partners for the solutions or dispersions of the hydrophilic polyaspartic esters of the invention which can be used accompanyingly in the formulation of the coating compositions of the invention are polyacrylates, more particularly those from the number-average molecular weight range 1000 to 10000 g/mol; hydroxyl-functional polyester resins, optionally containing urethane groups, of the type known from polyester resin and alkyd resin chemistry; hydroxyl-functional polyurethanes; or else polyurethanes or polyureas which are crosslinkable with polyisocyanates by virtue of the active hydrogen atoms present in the urethane or urea groups, respectively.

It is preferred here for aqueous solutions or aqueous dispersions of the hydrophilic polyaspartic esters of the invention to be used, and/or for the combination partners to be present in aqueous solvent.

The coating compositions of the invention can be prepared with accompanying use of organic solvents. Examples of suitable solvents are the customary paint solvents, of the kind already described as solvents for optional accompanying use in the preparation of the amine compound of the formula (I) and/or in the preparation of the hydrophilic polyaspartic esters of the invention, or else any desired mixtures of such solvents, in minor amounts, as for example in amounts of up to 30 wt %, preferably up to 20 wt %, more preferably up to 10 wt %, based on the amount of polyaspartic ester. The solvents may be added to the hydrophilic polyaspartic esters of the invention and/or to the NCO-functional crosslinking agent before the two components are united. The invention's aqueous solutions or dispersions of the hydrophilic polyaspartic esters of the invention may optionally in minor amounts also be admixed non-functional, aqueous, film-forming binders in order to achieve very specific properties, as additive for improving adhesion, for example. It is preferred, however, for the coating compositions of the invention to be prepared only using water as solvent, since such aqueous coating compositions have particularly advantageous environmental properties.

In general the preferably aqueous paints and coating compositions formulated with the hydrophilic polyaspartic esters of the invention or with the preferably aqueous solutions or dispersions thereof may optionally be admixed with further auxiliaries and adjuvants customary in the coatings sector. Examples of suitable auxiliaries and adjuvants in this context include flow control assistants, colour pigments, fillers, matting agents, organic or inorganic pigments, light stabilizers, coatings additives, such as dispersants, flow control agents, thickeners, defoamers and other auxiliaries, adhesion agents, fungicides, bactericides, stabilizers or inhibitors and catalysts or emulsifiers.

A further subject of the invention is a 2-component system comprising a component a), comprising at least one hydrophilic polyaspartic ester of the invention or at least one solution or dispersion of the hydrophilic polyaspartic esters, and a component b), comprising at least one NCO-functional crosslinking agent. Systems of this kind offer the advantage among others that hard and elastic coatings can be obtained which are distinguished by outstanding solvent resistance.

It is further preferred here that at least one further constituent of the 2-component systems is water, in which case the water may be present in component a) and/or in component b). A 2-component system of this kind has particularly advantageous environmental properties while still having very good physicochemical properties.

According to another preferred embodiment, aforementioned hydrophilically modified polyisocyanates are employed as NCO-functional crosslinking agents in the 2-component system.

In a further preferred embodiment, above 2-component systems, with use of non-blocked NCO-functional crosslinking agents as component b), may produce high-gloss, hard and elastic coatings even on room temperature drying, these coatings being distinguished by outstanding solvent resistance. It is also possible, however, for these 2-component systems to be dried under forced conditions at elevated temperature and/or by baking at temperatures up to 260° C. Where blocked NCO-functional crosslinking agents are used, according to another preferred embodiment, temperatures of at least 60° C., preferably of at least 80° C., may be needed until curing is complete.

Generally speaking, the 2-component systems of the invention can be used outstandingly for producing a coating on a substrate.

The coating compositions based on the solutions or dispersions of the hydrophilic polyaspartic esters of the invention may be applied by known techniques to any desired substrates, such as by spraying, brushing, flow coating or by means of rollers or doctor blades, for example. Examples of suitable substrates include metal, wood, glass, stone, ceramic materials, concrete, rigid and flexible plastics, textiles, leather or paper, which may also be provided, optionally, with customary primers as well prior to coating.

Consequently, substrates obtainable through use of the 2-component system of the invention are a further subject of the invention.

### EXAMPLES

The invention is illustrated in more detail below by examples.

Unless noted otherwise, all percentages are by weight.

The NCO contents were determined titrimetrically according to DIN EN ISO 11909.

The amine numbers were determined according to DIN 53176 by titration with hydrochloric acid.

All viscosity measurements took place using a Physica MCR 51 rheometer from Anton Paar Germany GmbH (DE) according to DIN EN ISO 3219.

Average particle sizes of aqueous dispersions were determined using a Zetasizer model DTS 5100 from Malvern Instruments GmbH (DE).

The Hazen colour number was determined spectrophotometrically according to DIN EN 1557 using a LICO 400 spectrophotometer from Lange, DE.

The amounts (mol %) of the allophanate, isocyanurate and/or uretdione structures present in the polyisocyanate components were calculated from the data from protocon-decoupled 13C NMR spectra (recorded on a Bruker DPX-400 instrument) and are based in each case on the sum total of allophanate, isocyanurate and/or uretdione structures present. In the case of HDI polyisocyanates, the individual structural elements have the following chemical shifts (in ppm): allophanate: 155.7 and 153.8; isocyanurate: 148.4; uretdione: 157.1.

### Starting Compounds

### Polyamine Component A)

### Polyamine Component A1)

Amine compound based on 4,4′-diaminodicyclohexylmethane and diethyl maleate, prepared according to Example b1)-I) of EP-A 0 403 921. The product obtained was clear and had the following characteristics:

Amine number: 203 mg KOH/g
Equivalent weight: 276 g/eq NH
Viscosity (23° C.): 1450 mPas

### Polyamine Component A2)

Amine compound based on 3,3′-dimethyl-4,4′-diaminodicyclohexylmethane and diethyl maleate, prepared according to Example b1)-D) of EP-A 0 403 921. The product obtained was clear and colourless and had the following characteristics:

Amine number: 193 mg KOH/g
Equivalent weight: 290 g/eq NH
Viscosity (23° C.): 1400 mPas

### Polyisocyanate Component B)

### Polyisocyanate Component B1)

1344 g (8.0 mol) of 1,6-diisocyanatohexane (HDI) were admixed at a temperature of 80° C. and under dry nitrogen with 350 g (1.0 mol) of a monofunctional polyethylene oxide polyether prepared starting from methanol and having a number-average molecular weight of 350 g/mol, and the mixture was stirred for 3 hours until an NCO content of 37.2% was reached, corresponding to complete urethanization. The reaction mixture was subsequently heated to 90° C. and 0.2 g of zinc(II) 2-ethyl-1-hexanoate was added as allophanatization catalyst. Because of the exothermally ensuing reaction, the temperature of the mixture rose to 105° C. After about 30 minutes, the NCO content of the reaction mixture was 34.7%. The catalyst was deactivated by addition of 0.2 g of ortho-phosphoric acid, and the unreacted monomeric HDI was removed in a thin film evaporator at a temperature of 130° C. and a pressure of 0.1 mbar. This gave 670 g of a virtually colourless, clear, polyether-modified polyisocyanate having the following characteristic data:

NCO content: 11.4%

### Monomeric HDI: 0.04%

Viscosity (23° C.): 148 mPas
NCO functionality: 2.0 (calculated)
Allophanate groups: 97.0 mol %
Isocyanurate groups: 3.0 mol %

### Polyisocyanate Component B2)

In accordance with the process described in Example 1, 1344 g (8.0 mol) of HDI were reacted with 500 g (1.0 mol) of a monofunctional polyethylene oxide polyether prepared starting from methanol and having a number-average molecular weight of 500 g/mol. The allophanatization reaction was initiated at an NCO content of 34.2% by addition of 0.2 g of zinc(II) 2-ethyl-1-hexanoate. On attainment of an NCO content of 31.9%, the reaction mixture was stopped with 0.2 g of ortho-phosphoric acid and worked up as described in Example 1. This gave 740 g of a colourless, clear, polyether-modified polyisocyanate having the following characteristic data:

NCO content: 9.0%

### Monomeric HDI: 0.06%

Viscosity (23° C.): 197 mPas
NCO functionality: 2.0 (calculated)
Allophanate groups: 97.0 mol %
Isocyanurate groups: 3.0 mol %

### Polyisocyanate Component B3)

In accordance with the process described in Example 1, 1344 g (8.0 mol) of HDI were reacted with 1400 g (1.0 mol) of a monofunctional ethylene oxide/propylene oxide polyether prepared starting from n-butanol and having an ethylene oxide content of 52% and having a number-average molecular weight of 1400 g/mol. The allophanatization reaction was initiated at an NCO content of 22.9% by addition of 0.3 g of zinc(II) 2-ethyl-1-hexanoate. On attainment of an NCO content of 21.4%, the reaction mixture was stopped with 0.3 g of ortho-phosphoric acid and worked up as described in Example 1. This gave 1737 g of a colourless, clear, polyether-modified polyisocyanate having the following characteristic data:

NCO content: 4.0%

### Monomeric HDI: 0.05%

Viscosity (23° C.): 394 mPas
NCO functionality: 2.0 (calculated)
Allophanate groups: 96.5 mol %
Isocyanurate groups: 3.5 mol %

### Polyisocyanate Component B4)

In accordance with the process described in Example 1, 1776 g (8.0 mol) of isophorone diisocyanate (IPDI) were reacted with 500 g (1.0 mol) of the polyether alcohol described for the preparation of the polyisocyanate component B2). The allophanatization reaction was initiated at an NCO content of 27.7% by addition of 0.3 g of zinc(II) 2-ethyl-1-hexanoate. On attainment of an NCO content of 25.8%, the reaction mixture was stopped with 0.3 g of ortho-phosphoric acid. The unreacted monomeric IPDI was removed in a thin film evaporator at a temperature of 160° C. and a pressure of 0.1 mbar. This gave 878 g of a pale yellow, clear, polyether-modified polyisocyanate having the following characteristic data:

NCO content: 6.6%

### Monomeric IPDI: 0.05%

Viscosity (23° C.): 386 mPas
NCO functionality: 2.0 (calculated)
Allophanate groups: 98.5 mol %
Isocyanurate groups: 2.5 mol %

### Polyisocyanate Component B5)

In accordance with the process described in Example 1, 1776 g (8.0 mol) of isophorone diisocyanate (IPDI) were reacted with 1400 g (1.0 mol) of the polyether alcohol described for the preparation of the polyisocyanate component B3). The allophanatization reaction was initiated at an NCO content of 19.8% by addition of 0.3 g of zinc(II) 2-ethyl-1-hexanoate. On attainment of an NCO content of 18.5%, the reaction mixture was stopped with 0.3 g of ortho-phosphoric acid. The unreacted monomeric IPDI was removed in a thin film evaporator at a temperature of 160° C. and a pressure of 0.1 mbar. This gave 1810 g of a pale yellow, clear, polyether-modified polyisocyanate having the following characteristic data:

NCO content: 3.4%

### Monomeric IPDI: 0.04%

Viscosity (23° C.): 850 mPas
NCO functionality: 2.0 (calculated)
Allophanate groups: 98.0 mol %
Isocyanurate groups: 2.0 mol %
Polyisocyanate component B6)

480 g (2.48 eq) of a polyisocyanate based on HDI, containing isocyanurate groups, having an NCO content of 21.7%, an average NCO-functionality of 3.5 (by GPC), a monomeric HDI content of 0.1% and a viscosity of 3000 mPas (23° C.), were introduced as an initial charge at 100° C. under dry nitrogen and with stirring, and 520 g (1.04 mol) of a monofunctional polyethylene oxide polyether prepared starting from methanol and having a number-average molecular weight of 500 g/mol were added over the course of 30 minutes, and the mixture was stirred further at this temperature until the NCO content of the mixture had dropped after about 2 hours to the figure of 6.0% corresponding to complete urethanization. After cooling to room temperature, the resultant colourless, clear, polyether-modified polyisocyanate mixture had the following characteristic data:

NCO content: 6.0%

### Monomeric HDI: 0.04%

Viscosity (23° C.): 4310 mPas
NCO functionality: 2.0 (calculated)

### Example 1

### Inventive

900 g (3.26 mol) of the polyamine component A1) were introduced under dry nitrogen at a temperature of 40° C. as an initial charge, 100 g (0.27 eq) of the polyisocyanate component BI) were added, corresponding to an equivalents ratio of NH:NCO of 12.0:1, and the mixture was stirred for approximately 2 hours until the isocyanate band (at around 2270 cm⁻¹) had disappeared completely from the IR spectrum. The clear polyaspartic ester of the invention, light in colour, had the following characteristic data:

Amine number: 166 mg KOH/g
Equivalent weight: 337 g/eq NH
Viscosity (23° C.): 1400 mPas
Colour number (APHA): 30 Hazen

300 g of this polyaspartic ester were introduced into a glass beaker, admixed with 200 g of deionized water and converted by simply stirring with a magnetic stirrer into a stable aqueous dispersion having a solids content of 60%. The average particle size was 144 nm.

### Example 2 to 11

### Inventive

In accordance with the process described in Example 1, the polyamine components A1) and A2) were reacted with the polyisocyanate components B1) to B6) to form hydrophilic polyaspartic esters of the invention. Table I hereinafter shows the compositions of the reaction batches (parts by weight in each case) and also characteristic data for the hydrophilic polyaspartic esters of the invention obtained and for the aqueous dispersions of the invention obtained from the polyaspartic esters. The hydrophilic polyaspartic esters obtained in inventive Examples 2 to 11 were light in colour, as was the hydrophilic polyaspartic ester obtained according to Inventive Example 1. This is evident from the Hazen colour numbers measured (APHA) of 17 to 58 Hazen.

TABLE 1

| | Example | | | | | | | | | |
|---|---|---|---|---|---|---|---|---|---|---|
| | 2 | 3 | 4 | 5 | 6 | 7 | 8 | 9 | 10 | 11 |
| Polyamine component A1) | 80 | 80 | 85 | 75 | — | — | — | — | — | 80 |
| Polyamine component A2) | — | — | — | — | 80 | 80 | 80 | 80 | 80 | — |
| Polyisocyanate component B1) | — | — | — | — | 20 | — | — | — | — | — |
| Polyisocyanate component B2) | 20 | — | — | — | — | 20 | — | — | — | — |
| Polyisocyanate component B3) | — | 20 | 15 | 25 | — | — | 20 | — | — | — |
| Polyisocyanate component B4) | — | — | — | — | — | — | — | 20 | — | — |
| Polyisocyanate component B5) | — | — | — | — | — | — | — | — | 20 | — |
| Polyisocyanate component B6) | — | — | — | — | — | — | — | — | — | 20 |
| NH:NCO [eq] | 6.8:1 | 15.2:1 | 21.6:1 | 11.3:1 | 5.1:1 | 6.4:1 | 14.5:1 | 8.8:1 | 17.0:1 | 10.1:1 |
| Colour number [Hazen] | 28 | 31 | 17 | 27 | 33 | 27 | 47 | 33 | 58 | 22 |
| Amine number [mg KOH/g] | 137 | 150 | 163 | 136 | 123 | 131 | 142 | 133 | 143 | 147 |
| Equivalent weight [g/eq NH] | 409 | 373 | 344 | 412 | 455 | 427 | 394 | 421 | 392 | 381 |
| Viscosity (23° C.) [mPas] | 1380 | 2410 | 2270 | 2590 | 1880 | 7700 | 2850 | 16,200 | 3940 | 5440 |
| APS [nm]^{a)} | 86 | 208 | 546 | 141 | 134 | 81 | 241 | 151 | 250 | 488 |

^{a)}APS = average particle size of an aqueous 60% dispersion

### Example 12

### Inventive

27 parts by weight of the hydrophilic polyaspartic ester of the invention from Example 8 were processed by the process described in Example 1 with 18 g of deionized water to give an aqueous 60% dispersion. 0.15 part by weight of BYK®-349 and 0.35 part by weight of BYK®-378 (silicone surfactants) were added, and then a solids content of 35% was set using a further 32.25 parts by weight of deionized water. Added to this batch were 13.6 parts by weight of an anionically hydrophilized HDI polyisocyanate marketed by Bayer MaterialScience (DE) under the designation Bayhydur® XP 2655 as a curing agent for aqueous 2K (2-component) polyurethane systems, having an NCO content of 21.2% and a viscosity (23° C.) of 3500 mPas, in the form of an 80% strength solution in 3-methoxy-n-butyl acetate (total amount of addition: 17.0 parts by weight) (corresponding to an equivalents ratio of isocyanate groups to amino groups of 1:1), and the mixture was homogenized by intensive stirring (2000 rpm).

Similarly, a further aqueous paint batch was formulated from 27 parts by weight of the polyaspartic ester from Example 10, using Bayhydur® XP 2655 as crosslinker (equivalents ratio of isocyanate groups:amino groups 1:1). The processing life of the application-ready paints was around 3 hours. The paints were applied to glass plates in a wet film thickness of 120 μm (about 55 μm dry) and dried at room temperature.

Colourless, glossy paint films were obtained, which had the following properties after one day:

| Polyaspartic ester from Example | 8 | 10 |
|---|---|---|
| Pendulum hardness [s] after 1 d/7 d ^{a)} | 61/134 | 87/210 |
| Solvent resistance after 7 d ^{b)} | | |
| Xylene | 2 | 1 |
| Ethyl acetate | 2 | 1 |
| Methoxypropyl acetate | 2 | 1 |
| Acetone | 5 | 5 |

^{a)} König pendulum hardness (DIN 53157)
^{b)} Exposure time 1 min in each case
Evaluation
0 = Paint surface is unchanged
1 = Paint surface shows permanent marking (edge)
2 = Paint surface can be scratched with the fingernail
3 = Paint surface can be scratched off partially with the fingernail
4 = Paint surface can be scratched off with the fingernail down to the substrate
5 = Paint surface is completely destroyed

Inventive Examples 1 to 11 show that the hydrophilic polyaspartic esters have Hazen colour numbers of 17 to 58 Hazen. The coatings obtainable from these hydrophilic polyaspartic esters of the invention are colourless, as shown for example by Example 12. As well as the quality whereby the resulting coatings can also be colourless, the coatings from Example 12 additionally possess very good mechanical stability and solvent resistance.

1. A hydrophilic polyaspartic ester obtained by reaction of
at least one polyamine component A), comprising an amine compound of the formula (I), 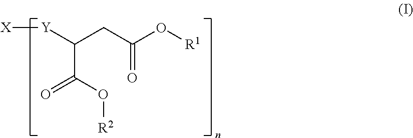
where
X is a saturated or unsaturated, linear or branched, aliphatic or cycloaliphatic or aromatic organic radical which is substituted or unsubstituted and/or has heteroatoms in the chain,
Y is a secondary amino group bonded to two carbon atoms,
R¹ and R² independently of one another are saturated or unsaturated, linear or branched, aliphatic or cycloaliphatic or aromatic organic radicals having 1 to 18 carbon atoms, and are substituted or unsubstituted and/or have heteroatoms in the chain, and
n is a natural number from 1 to 4,
with at least one polyisocyanate component B), comprising a polyisocyanate which comprises at least one chemically bonded, non-ionic, hydrophilic group, the ratio of the number of secondary amino groups Y to the number of isocyanate groups in the polyisocyanate being from 250:1 to 3:1.

2. The hydrophilic polyaspartic ester according to claim 1, wherein the ratio of the number of secondary amino groups Y in the formula (I) to the number of isocyanate groups in the polyisocyanate is from 200:1 to 5:1.

3. The hydrophilic polyaspartic ester according to claim 1, wherein the chemically bonded, non-ionic, hydrophilic group comprises at least one polyalkylene oxide polyether unit which consists to an extent of ≧40 mol % of ethylene oxide units and/or which has on average 5 to 80 ethylene oxide units.

4. The hydrophilic polyaspartic ester according to claim 1, wherein the polyisocyanate is at least one aliphatic, cycloaliphatic, araliphatic or aromatic polyisocyanate.

5. The hydrophilic polyaspartic ester according to claim 1, wherein the polyisocyanate comprises allophanate groups and optionally up to 10 mol % of isocyanurate groups and/or uretdione groups, based on the total amount of allophanate, isocyanurate and uretdione structures.

6. The hydrophilic polyaspartic ester according to claim 1, where in the at least one polyamine compound
X is an organic radical having a molecular weight of 28 g/mol to 6000 g/mol.

7. The hydrophilic polyaspartic ester according to claim 1, where in the at least one polyamine compound
X is an organic radical obtained by removing the amino group of the compounds 1,5-diamino-2-methylpentane, 2,4′-diaminodicyclohexylmethane, 4,4′-diaminodicyclohexylmethane, 3,3′-dimethyl-4,4′-diaminodicyclohexylmethane, or polypropylene glycol diamine of the molecular weight range 200 to 500 g/mol, and
n is the natural number 2.

8. The hydrophilic polyaspartic ester according to claim 1, where in the at least one polyamine compound
R¹ and R² independently of one another are aliphatic organic radicals having 1 to 9 carbon atoms.

9. A hydrophilic polyaspartic ester mixture comprising a compound comprising secondary amino groups and/or urea groups, wherein the ratio of the number of secondary amino groups to the number of urea groups is 249:1 to 2:1.

10. A solution or dispersion comprising at least one hydrophilic polyaspartic ester according to claim 1.

11. A solution or dispersion according to claim 10, comprising water as a solvent.

12. A polyurethaneurea obtained by overeating the at least one hydrophilic polyaspartic ester according to claim 1 with at least one NCO-functional crosslinking agent.

13. A method for producing a coating composition comprising mixing the at least one hydrophilic polyaspartic ester according to claim 1 with at least one NCO-functional crosslinking agent.

14. A method for producing a coating composition comprising mixing the at least one solution or dispersion according to claim 10 with at least one NCO-functional crosslinking agent.

15. A 2-Component system comprising a component a), comprising at least one hydrophilic polyaspartic ester according to claim 1, and a component b), comprising at least one NCO-functional crosslinking agent.

16. A 2-Component system comprising a component a), comprising at least one solution of dispersion according to claim 10, and a component b), comprising at least one NCO-functional crosslinking agent.

17. A method for producing a coating on a substrate comprising applying the 2-component system according to claim 15 to a substrate.

18. A coated substrate obtained by applying the 2-component system according to claim 15.
